(19) United States
(12) Patent Application Publication
(10) Pub. No.: US 2004/0103763 A1
(43) Pub. Date: Jun. 3, 2004

(54) T-handle ratchet wrench

(76) Inventor: Wen-Tsai Shyu, Taiping (TW)

Correspondence Address: Kuo-Hsiung Chiu, 13F., No. 23, Jiun-Ho Street, Peitun District, Taichung, 406, TW

(21) Appl. No.: 10/305,321

(22) Filed: Nov. 29, 2002

(51) Int. Cl. B25B 13/46

(52) U.S. Cl. 81/63.1

(57) ABSTRACT

The present invention relates to a T-handle ratchet wrench which includes a connection part located in the center of a main bar, while two flanks make up a handgrip. A driver extension goes through the connection part and a ratchet set can be assembled right inside the connection part. Meanwhile, a non-circular driver head or female part at the other end can attach onto various size sockets, thereby completing a simple T-handle ratchet wrench. In addition, the ratchet wrench has telescopic bars attached to the sides of the handgrip that can extend the length of the handgrip, which makes it easier for one to handle.

### BACKGROUND OF THE INVENTION

1. Fields of the Invention

The present invention relates to a T-handle ratchet wrench, and more particularly, to a T-handle socket driver whose length is telescopic and which can switch the direction of force being applied.

2. Description of the Prior Art

When people repair things, the most commonly seen types of hand-held tools include fork wrenches, ratchet socket wrenches, etc. Among these, the ratchet wrench is composed of a driver extension with one head for drive sockets, and a handgrip at the other end. The non-circular bottom of the driver extension is used to attach drive sockets, which can enclose the top or sides of the nut. When in use, most of the time one hand holds the head of the driver extension to secure a fixed position while the other hand holds the handgrip and then “turn with force in one direction, and then neutral in reverse.” As its design only allows force to be applied on one direction, therefore making it difficult to apply any more force.

As for traditional T-handle drivers, most are designed with a single size driver head, therefore. If one wants to have a complete set of drivers for various sizes of hexagonal nuts, then the user must spend quite a lot of money for another wrenches, thereby making it both uneconomical and impractical.

### SUMMARY OF THE INVENTION

Therefore, it is a primary object of the present invention to eliminate the above-mentioned drawbacks and to provide a T-handle ratchet wrench a T-handle ratchet wrench which includes a connection part located in the center of a main bar, while two flanks make up a handgrip. A driver extension goes through the connection part and a ratchet set can be assembled right inside the connection part. Meanwhile, a non-circular driver head or female part at the other end can attach onto various size sockets, thereby forming a simple type ratchet wrench. In addition, the ratchet wrench has telescopic bars attached to the sides of the handgrip that can extend the length of the handgrip to form a force-saving type ratchet wrench.

It is another object of the present invention to provide a T-handle ratchet wrench which has simple configuration, easy assembly and choices of neutral rotation or directions of applied force.

### BRIEF DESCRIPTION OF THE DRAWINGS

The accomplishment of this and other objects of the invention will become apparent from the following description and its accompanying drawings of which:

FIG. 1 is a perspective view of a simple embodiment of T-handle ratchet wrench in accordance with the present invention;

FIG. 2 is a front view of FIG. 1;

FIG. 3 is a front view of another simple embodiment of T-handle ratchet wrench in accordance with the present invention; and

FIG. 4 is a schematic view of a force-saving embodiment of the present invention.

### DETAILED DESCRIPTION OF THE PREFERRED EMBODIMENT

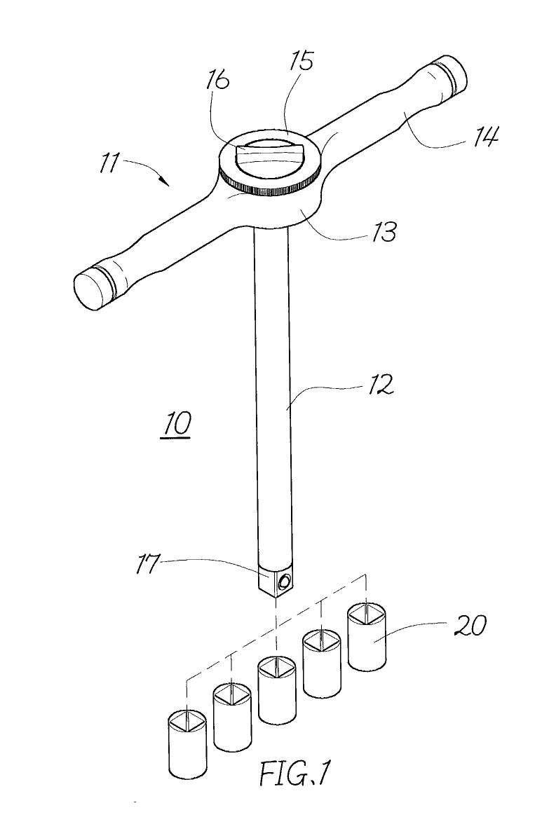

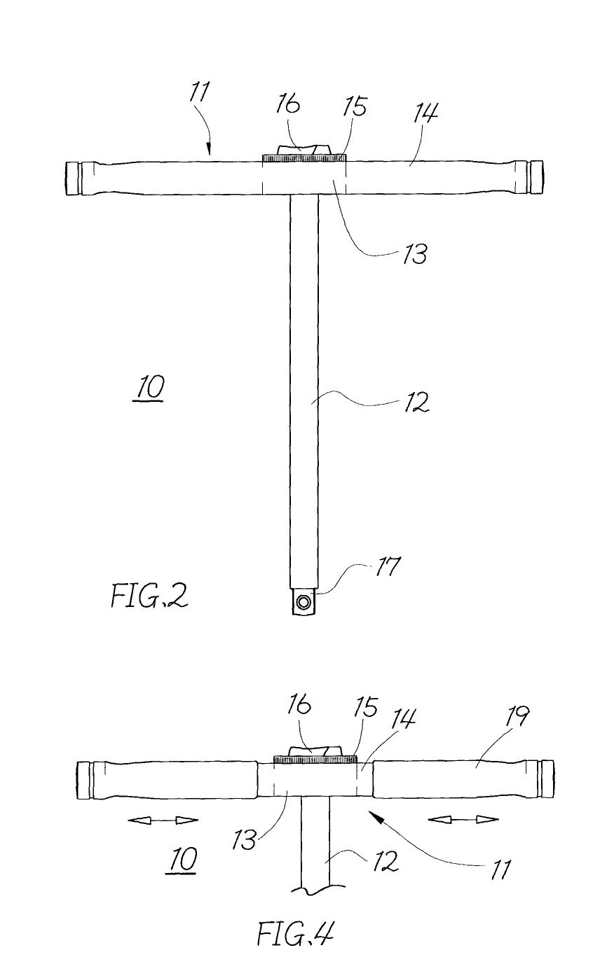

FIGS. 1 and 2 show a simple embodiment of T-handle ratchet wrench in accordance with the present invention. The T-handle ratchet wrench includes a connection part 13 located in the center of a main bar 11, while two flanks make up a handgrip 14. A driver extension 12 goes through the connection part 13 and a ratchet set 15 can be assembled right inside the connection part 13. Meanwhile, a non-circular driver head 17 at the other end can attach onto various size sockets 20, thereby completing a simple T-handle ratchet wrench 10.

When in use, the rotation button 16 on top of the ratchet set 15 can be used to determine the direction of neutral rotation. From the indicators on the rotation button 16, one can easily know the direction of reverse force, thereby allowing both hands to hold on to the driver head 17 and turn the sockets 20.

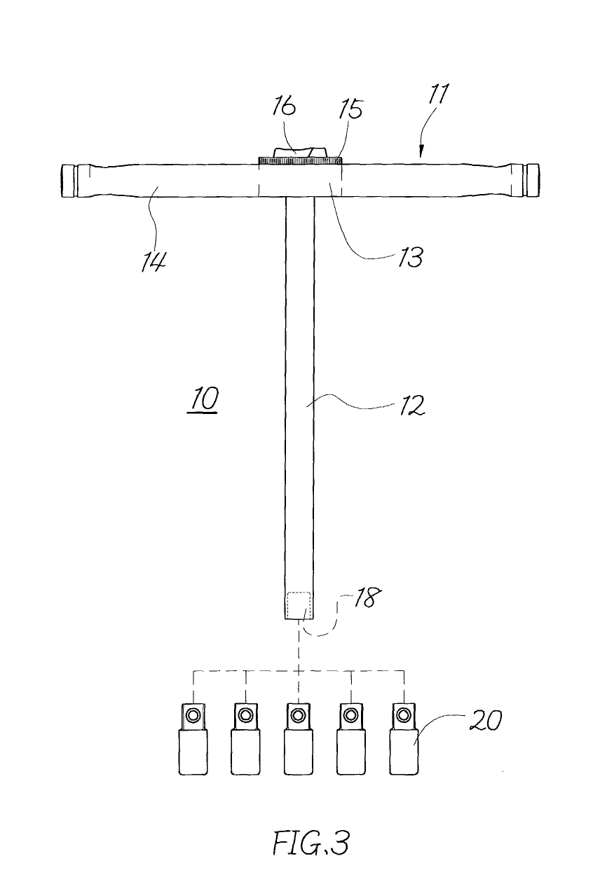

FIG. 3 shows a front view of another simple embodiment of T-handle ratchet wrench in accordance with the present invention. It includes a connection part 13 located in the center of a main bar 11, while two flanks make up a handgrip 14. A driver extension 12 goes through the connection part 13 and a ratchet set 15 can be assembled right inside the connection part 13, completing a simple T-handle ratchet wrench 10. The main difference with the aforementioned embodiment lies in that a non-circular female part 18 is disposed at the other end of the driver extension 12 to which different size sockets 20 can be attached.

FIG. 4 shows another type of force saving T-handle nut driver 10, which includes: a connection part 13 is located in the center of a main bar 11, while two flanks make up a handgrip 14. A driver extension 12 goes through the connection part 13 and a ratchet set 15 can be assembled right inside the connection part 13. The main difference with the two aforementioned embodiments lies in that this ratchet wrench 10 has telescopic bars 19 attached to the sides of the handgrip 14 that can extend the length of the handgrip, which makes it easier for one to handle.

In comparison with the aforementioned embodiments, the present invention has the following advantages:

1. Steadier handling: Dual side force application is much steadier and easier to position than single side force application.

2. Force-saving: As for enhancing torsion, using all one's force to firmly lock the compression spring to increase the strength of the ratchet engagement is not as force saving as the handgrip-extending ratchet wrench of the present invention.

3. Simple assembly: If the torsion was to be enhanced in the prior art, a large number of parts must be assembled and the process would be relatively complex. The present invention requires only few parts, which relatively simplifies the assembly process.

4. Easy to operate in special environments: There are deep crevices in automobiles. In order for conventional T-handle ratchet wrench to be used in these special environments, a longer driver extension must be attached and then the bits attached onto it for the ratchet wrench to be usable. For drivers where the bits are inserted, the length of the driver makes it difficult for the transmission of force. However, the present invention can still be easily used. Moreover, the additional indirect driver extension element is not needed therefore there is no problem of force transmission.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A T-handle ratchet wrench comprising:
connection part located in the center of a main bar, while two flanks make up a handgrip;
a driver extension going through said connection part;
a ratchet set assembled right inside said connection part; and
a non-circular driver head or female part disposed at the other end thereof and attached onto various size sockets.

2. The T-handle ratchet wrench of claim 1, wherein it's preferable that the ratchet wrench has telescopic bars attached to the sides of said handgrip that can extend the length of the handgrip, which makes it easier for one to handle.
